(19) United States
(12) Patent Application Publication
(10) Pub. No.: US 2013/0304396 A1
(43) Pub. Date: Nov. 14, 2013

(54) ONLINE STATISTICAL ANALYSIS OF NEUTRON TIME INTERVALS USING BAYESIAN PROBABILITY ANALYSIS

(71) Applicant: Sean E. Walston, Fremont, CA (US)

(72) Inventor: Sean E. Walston, Fremont, CA (US)

(21) Appl. No.: 13/466,829

(22) Filed: May 8, 2012

(51) Int. Cl. G06F 19/00

(52) U.S. Cl. 702/30

(57) ABSTRACT

Embodiments for providing rapid characterization of an unknown nuclear source are described. A sequential Bayesian particle filter is used to analyze in real time the neutron inter-arrival times to estimate the multiplication of the source, the mass of the spontaneously fissioning isotope, the neutron detection efficiency, and the neutron lifetime. A method defines an array of trial solutions, each specifying a combination of fissile parameters characterizing the source; determines a first time interval between a first neutron and a second neutron detected by the neutron detector; calculates a probability distribution of an array of the parameter values; determines additional time intervals between each subsequent successive pairs of neutrons detected by the neutron detector; and refines the probability distribution based on the additional time intervals using a recursive Bayesian process to estimate the most probable combination of parameter values.

### STATEMENT REGARDING FEDERALLY SPONSORED RESEARCH

The United States Government has rights in this invention pursuant to Contract No. DE-AC52-07NA27344 between the United States Department of Energy and Lawrence Livermore National Security, LLC.

### FIELD OF THE INVENTION

Embodiments are directed generally to nuclear physics, and more specifically, to techniques for analyzing neutron time intervals to quickly assay unknown fissile sources.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

When confronting a potential nuclear explosive, it is urgently necessary to be able to quickly determine the nature of the threat by characterizing the source. To this end, a variety of radiation detectors have been developed for use by first responders, including neutron multiplicity counters. Characterizing a potentially nuclear explosive source is particularly difficult when the source is heavily shielded and/or comprised of highly enriched uranium (HEU). In such a scenario, gamma-ray detectors see too few gamma rays emanating from the source to provide useful information, and radiography cannot penetrate the shielding. Thus, the detection and analysis of neutron emission is generally the only way to characterize the source.

Present detection systems require that the neutron multiplicity counter be placed close to the source and allowed to count for a period of time in order to populate multiplicity histograms. The neutron count data is then collected and transmitted to experts for offline analysis. The goal of this analysis is to calculate estimates for the multiplication M and the mass m of the special nuclear material (SNM) source. The multiplication is the average number of neutrons that result from a single neutron incident on the system. A multiplication greater than one implies that the material in question is fissile (i.e. SNM). In fissile materials, fission chains are typically initiated by the spontaneous fissions of a particular isotope. The mass of the spontaneously fissioning isotope is thus a key parameter regarding the characteristics of the source. Another useful parameter, in addition to the multiplication and mass, is the neutron lifetime λ⁻¹, which is the average time between the creation of a neutron and its detection. This parameter is useful for estimating the thickness of any hydrogenous materials around the SNM.

Neutrons from fissile materials tend to be correlated in time similar to the way that raindrops are correlated in time (e.g., raindrops are correlated with rain storms). This is due to the fission chains inherent in fissile materials. Neutrons that are correlated in time arrive at a neutron detector in bursts, which is a pattern that is differentiable from the pattern generated if the neutrons were random (i.e., uncorrelated). In general, benign neutron sources, such as those used for industrial purposes emit neutrons in a random manner. Dangerous weapons-useable sources, however, emit neutrons in a time-correlated manner. Examining the degree to which the neutrons are correlated in time provides a reliable method of characterizing an unknown source as benign or as a potentially dangerous (SNM) source that constitutes a potential threat.

Neutron multiplicity counters can in principle assay any type of fissile material. However, uranium emits relatively few neutrons and therefore poses a particularly tough problem. Neutron multiplicity counters need to spend a significant amount of time (typically half an hour or more) collecting data before the data can be analyzed with any reasonable hope of success. Furthermore, the transfer of the data and the offline analysis by the experts may reasonably be expected to take anywhere from ten minutes to half an hour as well. Such a time lag when analyzing a potentially lethal object can be catastrophic.

A neutron multiplicity counter records the detection of a neutron along with a measure of when the neutron was detected. Under the present neutron multiplicity paradigm, a neutron multiplicity counter is allowed to count for a period of time. The total count time is then sub-divided into many short time intervals or “gates” each of a specific duration T. If N is the number of time gates that are examined, then Bₙ(T) is the number of those time gates in which n neutrons were detected. For example, if three neutrons are counted during the first time gate, the number B₃(T) would be incremented by one, and if during the next time gate, two neutrons were counted; the number B₂(T) would be incremented by one; and so on for all N time gates. In this way, the count distribution Bₙ is built up. The probability of counting n neutrons during a time gate of length T is shown in Eq. 1:

$${b}_{n} ( T ) \approx \frac{{B}_{n} ( T )}{N} \qquad ( 1 )$$

In the above equation, assuming many time gates have been examined, i.e., N>>>1, the average number of neutrons counted during a single time gate of length T is

$$\overline{c} = {\sum }_{n = 0}^{∞} {b}_{n} ( T ) n \qquad ( 2 )$$

If all the neutrons were created independently of one another at an average rate of c̅ per amount of time T, the probability of counting n neutrons in time T would follow the well-known Poisson distribution. A fundamental characteristic of the Poisson distribution is that the variance equals the average number of neutrons counted during a single time gate. That is:

σ_{Poisson}²= c̅ (3)

In some cases, neutron sources can produce time-correlated neutrons, that is, the neutrons are not created independently of one another, but rather a single event can result in many neutrons. Two important examples are cosmic ray showers and the fission chains that occur in a quantity of fissile material.

In general, the variance of the bₙ distribution may be expressed in terms of the variance of the Poisson distribution, plus an additional term that takes into account any deviation from the Poisson distribution due to the correlated neutrons. This can be written as follows:

σ_{b}²= c̅(1+2Y_{2F}) (4)

In Eq. 4 above, the Y_{2F}(T) factor is called the Feynman variance and is calculated as follows:

$${Y}_{2 F} ( T ) = {R}_{2 F} ( 1 - \frac{1 - {e}^{- λ T}}{λ T} ) \qquad ( 5 )$$

With the R_{2F} constant given as:

$${R}_{2 F} = \frac{{R}_{2}}{{R}_{1}} \qquad ( 6 )$$

The above constant R_{2F} in Eq. 6 is a function of the detection efficiency ε, the escape multiplication Mₑ (which is closely related to the total multiplication M), the rates of induced and spontaneous fissions, F₁ and F_{S} respectively, and other parameters specific to the isotopes in question. The term in parentheses in Eq. 5 adjusts the Feynman variance for the duration of the time gate T in units of the neutron lifetime λ⁻¹, the mean time between the creation of the neutron and its detection. In general, it can be shown that

$${R}_{j} ≡ {e}^{j} \{ \begin{matrix}{F}_{1} {M}_{e} + {F}_{S} {M}_{e} \overline{{υ}_{S 1}} & j = 1 \\ {F}_{1} {M}_{e}^{2} \frac{{M}_{e} - 1}{\overline{{υ}_{1}} - 1} \overline{{υ}_{2}} + {F}_{S} {M}_{e}^{2} [ \overline{{υ}_{S 2}} + \frac{{M}_{e} - 1}{\overline{{υ}_{1}} - 1} \overline{{υ}_{S 1} {υ}_{2}} ] & j = 2 \\ {F}_{1} {M}_{e}^{3} \frac{{M}_{e} - 1}{\overline{{υ}_{1}} - 1} [ \overline{{υ}_{e}} + 2 \frac{{M}_{e} - 1}{{υ}_{1} - 1} \overline{{υ}_{2}^{2}} ] + & j = 3 \\ {F}_{S} {M}_{e}^{3} [ \begin{matrix}\overline{{υ}_{S 3}} + \frac{{M}_{e} - 1}{\overline{{υ}_{1}} - 1} ( \overline{{υ}_{S 1} {υ}_{3}} + 2 \overline{{υ}_{S 2} {υ}_{2}} ) + \\ 2 {( \frac{{M}_{e} - 1}{\overline{{υ}_{1}} - 1} )}^{2} \overline{{υ}_{S 1} {υ}_{2}^{2}}\end{matrix} ] & \end{matrix} \qquad ( 7 )$$

For the above Eq. 7, the quantities shown in Eqs. 8 and 9 are the μth combinatorial moments of the neutron multiplicity distribution for induced and spontaneous fission respectively. The Cᵥ and C_{S}_{ᵥ} terms are the probabilities that an induced and spontaneous fission creates v neutrons and are unique to the specific isotope.

$$\begin{matrix}\overline{{υ}_{μ}} = {\sum }_{υ = μ}^{∞} ( \begin{matrix}υ \\ μ\end{matrix} ) {C}_{υ} & ( 8 ) \\ \overline{{υ}_{S μ}} = {\sum }_{υ = μ}^{∞} ( \begin{matrix}υ \\ μ\end{matrix} ) {C}_{S υ} & ( 9 )\end{matrix}$$

The Feynman variance Y_{2F}(T) can also be expressed in terms of the probability distribution bₙ(T) directly as shown in Eq. 10 below, where M_{q} is the qth combinatorial moment of the probability distribution bₙ(T) as shown in Eq. 11:

$$\begin{matrix}{Y}_{2 F} ( T ) = \frac{{M}_{2}}{\overline{c}} - \frac{\overline{c}}{2 !} & ( 10 ) \\ {M}_{q} = {\sum }_{n = q}^{∞} ( \begin{matrix}n \\ q\end{matrix} ) {b}_{n} ( T ) & ( 11 )\end{matrix}$$

Using similar reasoning, the analysis of the Feynman variance can be extended and the quantity Y_{3F} derived. It can be shown that the analogous equation for Y_{3F} is

$${Y}_{3 F} = {R}_{3 F} ( 1 - \frac{3 - 4 {e}^{- λ T} + {e}^{- 2 λ T}}{2 λ T} ) \qquad ( 12 )$$

where

$${R}_{3 F} = \frac{{R}_{3}}{{R}_{1}} \qquad ( 13 )$$

As expressed in terms of the combinatorial moments of the count distributions, Eq. 12 can be written as:

$${Y}_{3 F} = \frac{{M}_{3}}{\overline{c}} - {M}_{2} + \frac{{\overline{c}}^{2}}{3} \qquad ( 14 )$$

In practice, the distributions bₙ(T) are determined for a series of time gates, e.g. T=1, 2, 3 . . . 512 μs. FIG. 1 is a graph illustrating the probability distribution of an example neutron source as compared with a Poisson distribution having the same count rate. The curve 102 illustrates a probability distribution bₙ(T) with T=512 μs for a 1% efficient neutron detector (i.e., ε=0.01) near a highly multiplying poly-reflected 4.48 kg Pu ball. The moderation is sufficient to make λ⁻¹=180 μs, and the detector was allowed to count for 10 seconds. A Poisson distribution curve 104 with the same count rate is shown for comparison with the probability distribution curve 102.

As a practical matter, Y_{2F}(T) and Y_{3F}(T) are easy to compute from the distributions bₙ(T) using Eqs. 2, 10, 14, and 11, above. The 512 resulting values for Y_{2F}(T) and Y_{3F}(T) (or at least a significant subset depending on the quality of the data) are then fitted, respectively, to the functional forms in Eqs. 5 and 12 using a χ²-fit with free parameters λ, R_{2F}, and R_{3F}. If the detection efficiency is known a priori, and with assumptions for the spontaneously fissioning isotope and the isotope propagating the fission chains, these quantities in turn can be solved to determine Mₑ and F_{S} (often with the reliable approximation that F_{S}>>F₁≅0) using Eq. 7. The F_{S} value in turn can be used to determine the mass m of the spontaneously fissioning isotope.

A significant disadvantage of the multiplicity analysis performed in accordance with the above description is the need to count for a significant amount of time (particularly with a weak source) in order to populate the bins in the multiplicity histograms Bₙ(T) such as the one shown in FIG. 1. Present systems that perform such analysis offline at a remote location from the unknown source also add a significant amount of transmission, analysis, and report time to the overall process.

What is needed, therefore, is an SNM analysis system that is field deployable and that performs an analysis of the critical characteristics of unknown fissile materials in real-time without requiring lengthy offsite analysis.

### BRIEF SUMMARY

Embodiments are generally directed to an online statistical method of analyzing neutron time intervals in a manner that greatly reduces the amount of time required to calculate multiplication M and mass m, and the neutron lifetime λ⁻¹ of any SNM. In a system of an embodiment, each time a neutron enters the detector, the algorithm computes these parameters online from the amount of time elapsed since the previous neutron. The best answer, given the existing data, is made available onsite by the algorithm on a continuous basis, and there is no need to transfer and analyze the data remotely offline.

In a system of an embodiment, a neutron multiplicity counter obtains neutron arrival time information. The time interval between the last count and the next-to-last count is determined by taking the difference between their respective arrival times. A recursive Bayesian particle filter algorithm then estimates the mass m, multiplication M, detector efficiency ε, and neutron lifetime λ⁻¹. Given a time interval, a probability distribution is computed over an array of test values for mass m, multiplication M, detector efficiency ε, and neutron lifetime λ⁻¹. When the next time interval becomes available (because another neutron was counted in the detector), another probability distribution is computed over the array of test values for mass m, multiplication M, detector efficiency ε, and neutron lifetime λ⁻¹. Bayes' theorem is then used to update the original probability distribution with the new probability distribution resulting in a distribution that is based on both time intervals. Each time a neutron gets detected, the time interval between this neutron and the preceding neutron is used to compute a new probability distribution over the array of test values and this new distribution then updates the existing probability distribution resulting from all the prior time intervals. At any given time, the set of values for mass, multiplication, detector efficiency, and neutron lifetime that has the highest probability according to the most up-to-date distribution determines a best estimate for the characteristics of the source. Alternately, the mean values for mass, multiplication, detector efficiency, and neutron lifetime as weighted by the most recent probability distribution also determines a best estimate for the characteristics of the source. If offline analysis is available, it can be used as a cross-check to verify the results obtained onsite by the recursive Bayesian particle filter algorithm. Embodiments are provided in an online software program that utilizes existing neutron multiplicity counter hardware systems.

The analysis performed under embodiments allows the analysis to be performed locally and in real time and eliminates the need to wait for count histograms Bₙ(T) to populate as described in the Background section.

Methods and systems for providing rapid characterization of an unknown nuclear source are described. A recursive Bayesian particle filter that incorporates the underlying physics of neutrons emanating from an SNM source is used to analyze, in real time, the neutron inter-arrival times to estimate the multiplication M of the SNM, the mass m of the spontaneously fissioning isotope, the neutron detection efficiency ε, and the neutron lifetime λ⁻¹.

Any of the embodiments described herein may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is a graph illustrating the probability distribution of an example neutron source as compared with a theoretical (Poisson) distribution.

FIG. 2 is a flow diagram of a neutron detector system that performs statistical analysis of neutron time intervals, under an embodiment.

FIG. 3 is a flowchart representing a method of determining the most probable combination of parameters for an unknown source, under an embodiment.

FIG. 4. is a plot that illustrates the convergence of the mean estimation of the rate parameter, under an embodiment.

FIG. 5 is a “waterfall” plot showing the waiting time between neutron counts plotted as a function of arrival time.

FIG. 6 is a graphical representation of a histogram of neutron time intervals as calculated under an embodiment.

FIG. 7 is a plot illustrating an induced fission neutron multiplicity distribution for ²³⁵U.

FIGS. 8A and 8B illustrate plots of a fission chain neutron multiplicity distribution for ²³⁵U for chains initiated by a single neutron, under an embodiment.

FIG. 9 is a plot that illustrates the spontaneous fission neutron multiplicity distribution for ²³⁸U.

FIGS. 10A and 10B illustrate plots of a fission chain neutron multiplicity distribution for ²³⁵U, in accordance with an embodiment.

FIG. 11 is a plot illustrating P₁(λᵢ) for values of λ showing a uniform probability distribution, under an embodiment.

FIG. 12 is a plot P₂(λᵢ) for values of λ under an example and for a P₁(λᵢ) distribution as shown in FIG. 11.

FIG. 13 is a plot P₃(λᵢ) for values of λ under an example and for a P₂(λᵢ) distribution as shown in FIG. 12.

FIG. 14 illustrates the derivation of a final value of λ through a Bayesian process, under an embodiment.

FIG. 15 illustrates example graphs of the evolution of the plots for the [symbol] {m, M, ε and λ⁻¹} [symbol] parameter values over a period of about half a minute for an experiment in an example application.

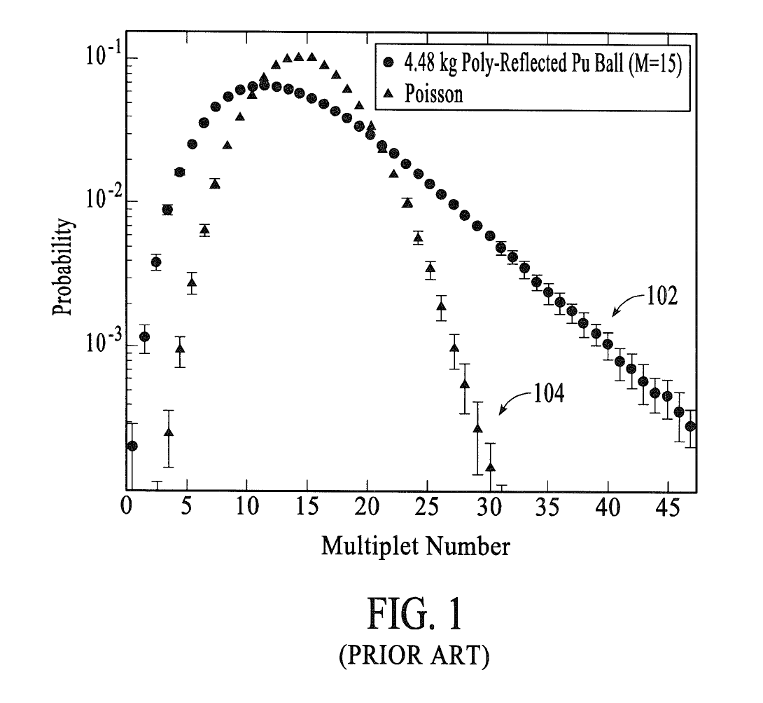

### DETAILED DESCRIPTION

Systems and methods are described for implementing online statistical analysis of neutron time intervals using Bayesian probability analysis to assay unknown fissile sources. Aspects of the one or more embodiments described herein may be implemented on one or more processing devices executing software instructions. Such processing devices may be embodied as field-deployable equipment, such as measuring instruments, or as computers comprising a multiplicity counter system and particle filter system.

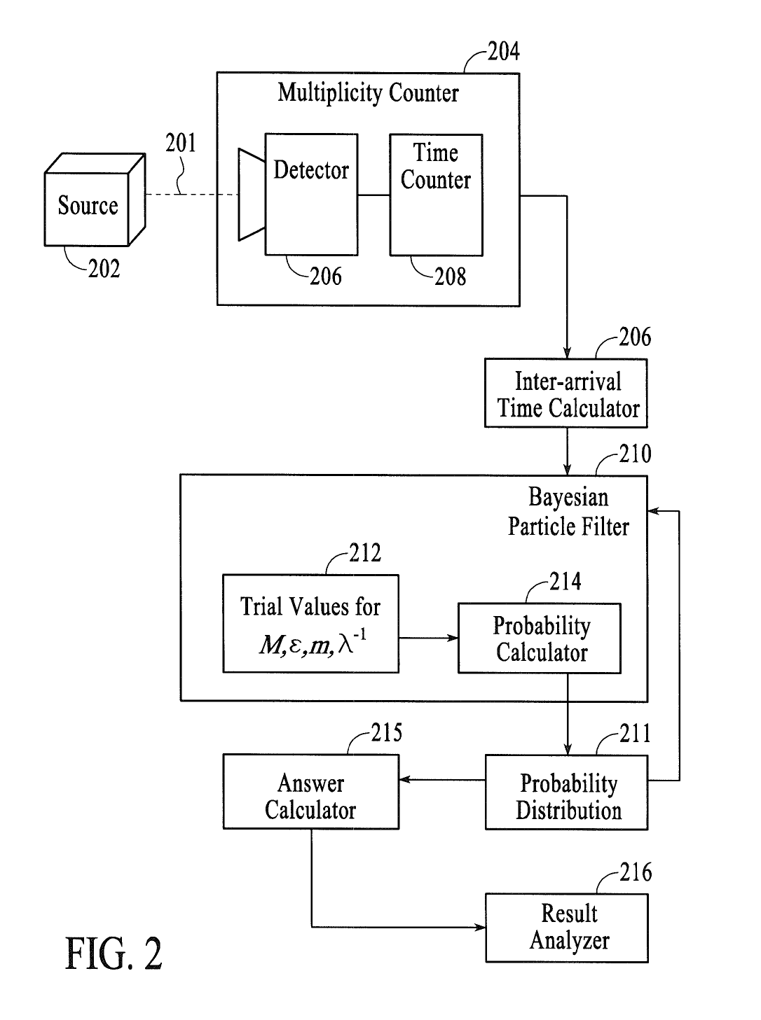

FIG. 2 is a flow diagram of the components and processes of a neutron detector system that performs statistical analysis of neutron time intervals, under an embodiment. The neutron detector system is used to assay an unknown source 202 that is presumed to be fissile, and the overall system is configured to determine whether this source is potentially dangerous or benign. As shown in FIG. 2, the unknown source 202 is examined using a neutron detector system that includes a detector 206 and a time counter 208. These two components may be combined to form a multiplicity counter 204 that detects the arrival of a stream of neutrons 201 from the source 202 and records the time that each neutron is detected, such as by assigning a time stamp to each arrival event. The time information is processed by an inter-arrival time calculator 206 that provides the actual time interval between each pair of successive neutrons. In an embodiment, the inter-arrival time calculator includes a subtractive process that subtracts successive timestamp values, such as by processing two lists of timestamps that are offset by one neutron arrival event. This yields the time difference between each pair of successively detected neutrons.

The recursive Bayesian particle filter process 210 performs a recursive refinement process to derive the optimum values for mass m, multiplication M, time constant λ⁻¹, and efficiency ε parameters after each detected neutron. Inter-arrival times calculated by calculator 206 are used by particle filter process 210 to compute the probability distribution 211 over a defined array of parameter combinations of the source. A result analyzer component 216 can then be used to determine the most likely combination of parameters defining the source and to characterize the source as dangerous or benign based on this set of matching parameters.

In an embodiment, the array of parameter combinations comprises an array of all practical combinations of values for the following parameters: mass m, multiplication M, detector efficiency ε, and neutron lifetime λ⁻¹. The array 212 represents a body of trial data solutions with each solution representing a possible characterization of the source based on the m, M, ε, λ⁻¹ parameters. The combination that is most probable as determined by the operation of the probability calculator 214 represents the likely characterization of the source. The system-level embodiment of FIG. 2, applies Bayesian statistical methods to the ever-increasing body of inter-arrival time data to refine the average rate and to determine the probability of each trial solution in the array, until a final most probable solution is identified with satisfactorily high probability. In an embodiment, a minimum probability threshold is defined, and any value above this minimum probability threshold is defined as satisfactorily high. The minimum probability threshold may be any value that is appropriate for the particular assay being performed, and may depend on the source 202, environmental conditions, and any constraints related to the assay process.

The probability calculator 214 of the Bayesian particle filter 210 calculates the probability corresponding to every entry in the trial solution array in real-time as each new neutron is detected. The probability calculator 214 generates a probability distribution 211 that can be refined through iterative particle filter operations. Thus, the probability distribution 211 used increases or decreases over time, as further iterations are performed. After a sufficient number are performed, the resulting parameter set is processed by answer calculator 215. This calculator returns the most probable values for the set of parameters m, M, ε, λ⁻¹, which can then be provided to result analyzer 216 for assaying the source 202.

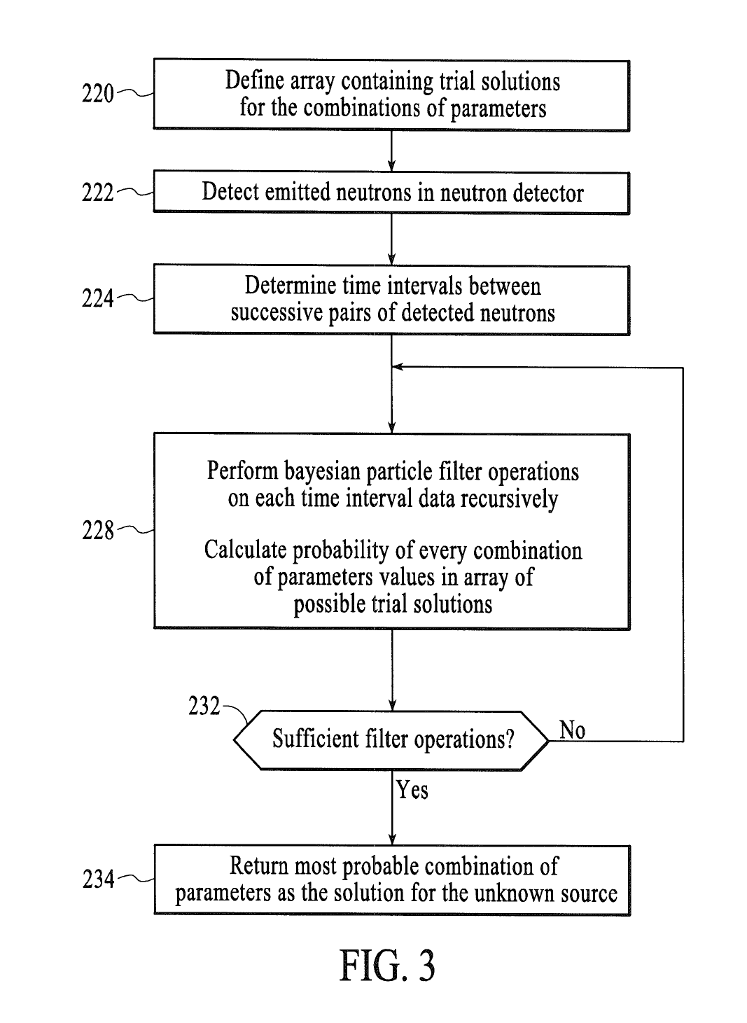

FIG. 3 is a flowchart representing a method of determining the most probable combination of parameters for an unknown source, under an embodiment. An initial step of the method comprises defining the array of trial solutions 212 for the various combinations of mass m, multiplication M, detector efficiency ε, and neutron lifetime λ⁻¹ parameters, as shown in block 220. In general, each parameter may have a certain range of realistic values given certain assumptions regarding the source. For example, it may be assumed that the source is uranium. As discussed later, in such a case, the array of trial solutions may have a range of 23 values for m, 20 values for M, 12 values for ε, and 19 values for λ⁻¹. In this case, the array of trial solutions will have 104,880 entries, of which one entry is the most probable entry that characterizes the source with respect to these parameters.

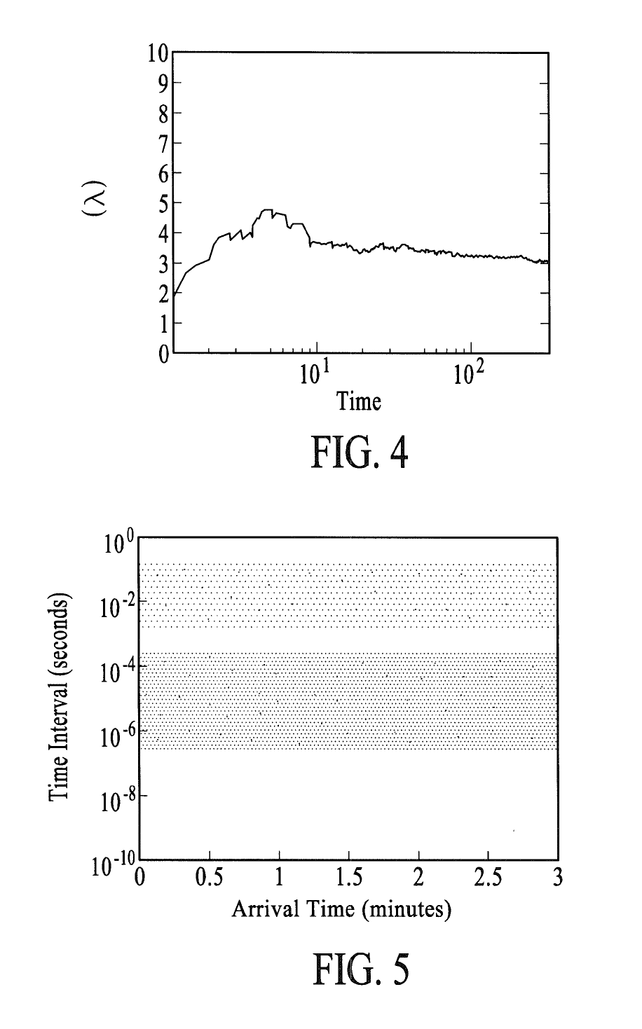

Once the detector unit is placed in the appropriate proximity of the source, the emitted neutrons are detected in the neutron detector stage, block 222. The time interval between successive pairs of neutrons is then determined, block 224. For each time interval, a recursive Bayesian particle filter calculates the probability of every combination of parameters, block 228. Thus, a probability corresponding to every entry in the trial solution array is calculated in real-time as each new neutron is detected. In this manner, the probability of each combination of parameter values increases or decreases over time, until a sufficient number of time-interval data has been collected. This sufficient number of data points can be defined by a set minimum threshold level as specified by the actual implementation constraints and requirements. In an embodiment, a threshold value can be defined to indicate a “settled” parameter set after a sufficient number of particle filter iterations have been performed. The decision block 232 determines whether or not a sufficient number of particle filter iterations have been performed to generate a settled parameter set. If not, then further particle filter operations are performed on subsequent detected neutrons. If the probability for a particular set of parameters m, M, ε, λ⁻¹ is sufficiently high, as determined in block 232, the parameter values from the final recursive operation of the filter process 228 are then taken as the solution for the source, block 234. FIG. 4 is a plot that illustrates an example of convergence of a particular parameter (λ) over a period of time for a number of time intervals in which the most probable value of the parameter is determined through the recursive filter process.

As shown in FIG. 2, a system under embodiments uses the inter-arrival time between successive neutrons in order to derive certain characteristics of an unknown source. This analysis has the advantage of not requiring long count times to populate multiplicity histograms and could be used to compute a solution every time a neutron enters the detector 206. This results in a method that greatly reduce the amount of time required to obtain an answer regarding the neutron characteristics of the source.

As stated above, an important characteristic of fissile material is the emission of correlated neutrons. The calculation to determine the inter-arrival time of correlated neutrons is given in Eq. 18 as follows (again with the reliable approximation that F_{S}>>F_{J}≅0):

$${I}_{0} ( T ) = {R}_{1} {r}_{0} ( T ) {β}_{0} ( T ) + \frac{{F}_{S}}{{R}_{1}} {\sum }_{k = 2}^{∞} {e}_{k} ( ɛ ) ( {\sum }_{j = 1}^{k = 1} j {e}^{- j λ T} ) λ {b}_{0} ( T ) \qquad ( 18 )$$

The waiting time between neutron counts can be plotted as a function of arrival time in a “waterfall” plot, as shown in FIG. 5. The upper band results from spontaneous fissions of ²³⁸U while the lower band results from fission chains in the multiplying ²³⁵U. FIG. 5 illustrates an example waterfall plot of the waiting time between neutron counts versus arrival time for simulated data in accordance with embodiments, for ²³⁵U with multiplication M=17, detection efficiency ε=2.5% and λ⁻¹=75 μs driven by spontaneous fissions from 10 kg ²³⁸U. The upper band 502 results from spontaneous fissions of ²³⁸U while the lower band 504 results from fission chains in the multiplying ²³⁵U.

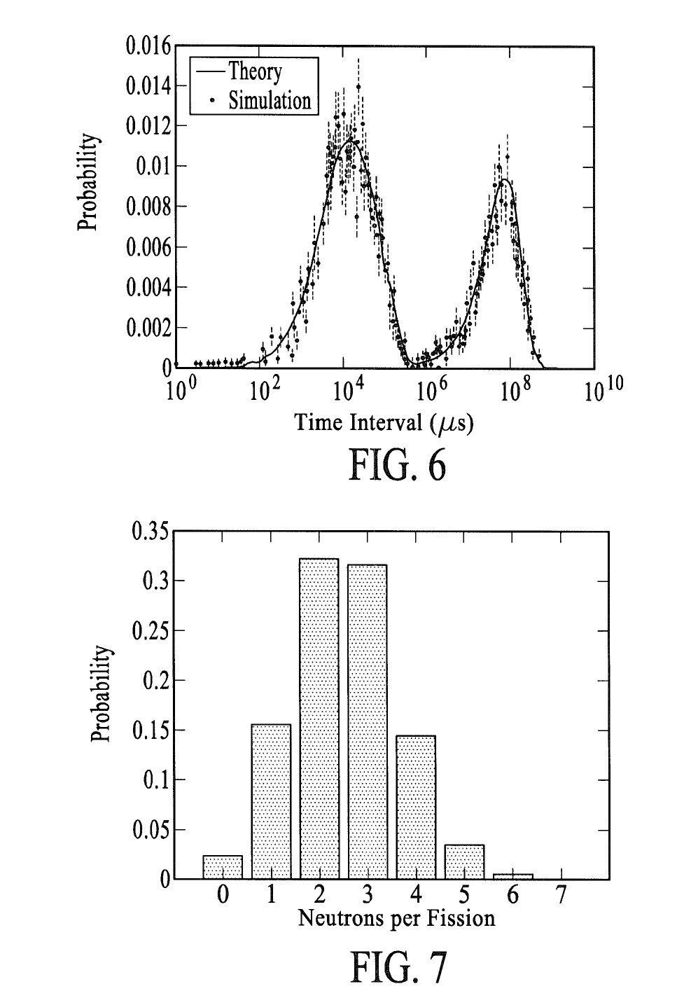

The “waterfall” plot, such as that shown in FIG. 5 can be condensed into a histogram from the waiting times by considering the number of points within a horizontal band. FIG. 6 is a graphical representation of a histogram of neutron time intervals as calculated by Eq. 18 and simulated data for ²³⁵U with multiplication M=17, detection efficiency ε=2.5% and λ⁻¹=75 μs driven by spontaneous fissions from 10 kg ²³⁸U.

In Eq. 18, the count rate for a multiplying system (from Eq. 7) is:

R₁=εF_{S}Mₑ v̅_̅{̅S̅1̅}̅ (19)

The probability of detecting k neutrons from a single fission chain is:

$${e}_{k} ( ɛ ) = {\sum }_{n = k}^{∞} {P}_{Sn} ( \begin{matrix}n \\ k\end{matrix} ) {{ɛ}^{k} ( 1 - ɛ )}^{n - k} \qquad ( 20 )$$

In Eq. 20, P_{Sn}, is the fission chain multiplicity distribution for chains initiated by spontaneous fissions. The probability that no neutrons from the same fission chain were detected within a time T after the first neutron was detected is:

$${r}_{0} ( T ) = \frac{{F}_{S}}{{R}_{J}} {\sum }_{k = 1}^{∞} {e}_{k} ( ɛ ) ( {\sum }_{j = 0}^{k = 1} {e}^{- j λ T} ) \qquad ( 21 )$$

The probability that no neutrons were detected within a time T after the first neutron was detected is:

β₀(T)=r₀(T)b₀(T) (22)

The probability to detect no neutrons during any random time interval of length T is:

b₀(T)=e^{-[Σ}^{ⱼ₌₁}^{^{∞}}^{Λ}^{ⱼ}^{(T)]} (23)

In Eq. 23, the probability for detecting k neutrons from a single fission chain within a time interval T is denoted Λ(T), and is as shown in Eq. 24:

$${Λ}_{k} ( T ) = {F}_{S} {\sum }_{n = k}^{∞} {P}_{Sn} ( \begin{matrix}n \\ k\end{matrix} ) [ {\int }_{- ∞}^{∞} {( ɛ η )}^{k} {( 1 - ɛ η )}^{n - k} d s + {\int }_{0}^{T} {( ɛ ζ )}^{k} {( 1 - ɛ ζ )}^{n - k} d s ] \qquad ( 24 )$$

For Eq. 24, the quantities η and ζ are defined as:

η=e^{λs}(1−e^{-λT}) (25)

ζ=1−e^{-λ(T-s)} (26)

Using these quantities, the first integral reduces to:

$${\int }_{- ∞}^{0} {( e η )}^{k} {( 1 - e η )}^{n - k} d s = \frac{B [ e ( 1 - {e}^{- λ T} ) k , n + 1 - k ]}{λ} \qquad ( 27 a )$$

and the second integral reduces to:

$${\int }_{0}^{T} {( ɛ ζ )}^{k} {( 1 - ɛ ζ )}^{n - k} d s = - \frac{1}{λ} {\sum }_{j = 0}^{k - 1} {ɛ}^{j} B [ ɛ ( 1 - {e}^{- λ T} ) ; k - j , n + 1 - k ] + \frac{{ɛ}^{k }}{λ} {\sum }_{j = 0}^{n - k - 1} \frac{{( 1 - ɛ )}^{j} [ 1 - {( 1 - ɛ + ɛ {e}^{- λ T} )}^{n - k - j} ]}{n - k - j} + T {{ɛ}^{k} ( 1 - ɛ )}^{n - k} \qquad ( 27 b )$$

In Equations 27a and 27b, above, the function B(z; a, b) is the incomplete beta function.

Fundamental to the distribution of neutron inter-arrival times is the fission chain multiplicity distribution, P_{Sn}. This distribution is most easily computed from the probability generating function for the fission chain neutron population, which in the infinite time limit reduces to:

$$h ( y ) = {\sum }_{n = 0}^{∞} {P}_{n} {y}^{n} \qquad ( 28 )$$

In Eq. 28 above, Pₙ is the fission chain multiplicity distribution for chains initiated by induced fission. This equation satisfies the Bohnel equation,

$$h ( y ) = ( 1 - p ) y + p {\sum }_{υ} {{C}_{υ} [ h ( y ) ]}^{υ} \qquad ( 29 )$$

By solving this equation, one can obtain an explicit expression for the generating function,

$$h ( y ) = ( 1 - p ) y + {( 1 - p )}^{n} {y}^{n} {\sum }_{k = 1}^{∞} {\sum }_{{υ}_{0} , {υ}_{1} , {υ}_{2} , … } \frac{{p}^{k} ( k - 1 + n ) !}{n ! {υ}_{0} ! {υ}_{1} ! {υ}_{2} ! …} ( {C}_{0}^{{υ}_{0}} {C}_{1}^{{υ}_{1}} {C}_{2}^{{υ}_{2}} … ) \qquad ( 30 )$$

The quantity k has the interpretation of the total number of fissions, where k is:

k=v₀+v₁+v₂+v₃+ . . . (31)

Since Cᵥ is the induced fission neutron multiplicity, v₀ is the number of fissions which produce zero neutrons, v₁ the number of fissions which produce one neutron, v₂ the number of fissions which produce two neutrons, and so on. FIG. 7 is a plot illustrating an induced fission neutron multiplicity distribution for ²³⁵U, and is an example of a plot used in conjunction with embodiments of the method of FIG. 3.

If the first neutron appeared in the system by immaculate conception, and subsequently there were k fissions, then at a minimum, k−1 neutrons were produced by the fission chain the minus one is there because that first neutron was not produced by the fission chain. In addition to these k−1 neutrons, however, some number n additional neutrons may have been produced by the fission chain, which are neutrons that in principle are available for detection. The total number of neutrons produced by the fission chain in relation to the fission neutron multiplicities is thus given by Eq. 32 as:

k−1+n=v₁+2v₂+3v₃+ . . . (32)

This Eq. 32 says that the total number of neutrons produced by the fission chain must add up to the number of fissions v₁ that produced one neutron plus twice the number of fissions v₂ which produced two neutrons, and so on.

From Eq. 28, the probability Pₙ that a fission chain generates n neutrons is just the coefficient on yⁿ from the probability generating function, that is:

$${P}_{n} = {δ}_{jn} ( 1 - p ) + {( 1 - p )}^{n} {\sum }_{k = 1}^{∞} {\sum }_{{υ}_{0} , {υ}_{1} , {υ}_{2} , … } \frac{{p}^{k} ( k - 1 + n ) !}{n ! {υ}_{0} ! {υ}_{1} ! {υ}_{2} ! …} ( {C}_{0}^{{υ}_{0}} {C}_{1}^{{υ}_{1}} {C}_{2}^{{υ}_{2}} … ) \qquad ( 33 )$$

Numerical computation of the fission chain neutron multiplicity distribution Pₙ directly from this formula is impractical as it requires the computation of all the combinations of v₀, v₁, v₂, . . . , where Σᵢvᵢ=k. As a simple example of this, consider a bakery where there are three different kinds of doughnuts to choose from (e.g., chocolate, glazed, and jelly), and it is desired to purchase a box of a dozen. The number of ways to choose a dozen doughnuts can be calculated as:

$$( \begin{matrix}12 + 3 - 1 \\ 12\end{matrix} ) = 91.$$

This mirrors the situation where fissions can produce zero, one, or two neutrons, and we want to consider a fission chain with a dozen fissions. In reality, fissions can produce anywhere from zero up to around ten neutrons typically. The number of ways of choosing some number of objects generally explodes as the number of objects increases. For a bakery that offers ten different kinds of doughnuts, there are 293,930 ways of filling a box of a dozen. Computing all these combinations of v₀, v₁, v₂, . . . , therefore becomes tedious and impractical.

However, Eq. 33 can be written another way to more easily allow numerical calculation. First note that the second term in Eq. 33,

$${( 1 - p )}^{n} {\sum }_{k = 1}^{∞} {\sum }_{{υ}_{0} , {υ}_{1} , {υ}_{2} , …} \frac{{p}^{k} ( k - 1 + n ) !}{n ! {υ}_{0} ! {υ}_{1} ! {υ}_{2} ! …} ( {C}_{0}^{{υ}_{0}} {C}_{1}^{{υ}_{1}} {C}_{2}^{{υ}_{2}} … ) = {\sum }_{k = 1}^{∞} \frac{{{p}^{k} ( 1 - p )}^{n}}{k + n} \frac{( k + n ) !}{k ! n !} {\sum }_{{υ}_{0} , {υ}_{1} , {υ}_{2} , …} \frac{k !}{{υ}_{0} ! {υ}_{1} ! {υ}_{2} ! …} ( {C}_{0}^{{υ}_{0}} {C}_{1}^{{υ}_{1}} {C}_{2}^{{υ}_{2}} … ) = {\sum }_{k = 1}^{∞} \frac{β ( k , n , p )}{k + n} {\sum }_{{υ}_{0} , {υ}_{1} , {υ}_{2} , …} \frac{k !}{{υ}_{0} ! {υ}_{1} ! {υ}_{2} ! …} ( {C}_{0}^{{υ}_{0}} {C}_{1}^{{υ}_{1}} {C}_{2}^{{υ}_{2}} … ) \\ where \\ β ( k , n , p ) = {{p}^{k} ( 1 - p )}^{n} \frac{( k + n ) !}{k ! n !} \qquad ( 34 )$$

is the binomial distribution. The remaining multinomial term is most easily dealt with by noting that:

$${\sum }_{{υ}_{0} , {υ}_{1} , {υ}_{2} , …} \frac{k !}{{υ}_{0} ! {υ}_{1} ! {υ}_{2} ! …} ( {C}_{0}^{{υ}_{0}} {C}_{1}^{{υ}_{1}} {C}_{2}^{{υ}_{2}} … ) {z}^{{υ}_{1} + 2 {υ}_{2} + {3}_{{υ}_{3}} + …} = {[ {\sum }_{υ} {C}_{υ} {z}^{υ} ]}^{k} \qquad ( 35 )$$

This is really nothing more than a massive polynomial in z,

$${[ {\sum }_{υ} {C}_{υ} {z}^{υ} ]}^{k} = {C}_{0}^{k} + {kC}_{0}^{k - 1} {C}_{1} z + ( {T}_{k} {C}_{0}^{k - 2} {C}_{1}^{2} + {kC}_{0}^{k - 1} {C}_{2} ) {z}^{2} + … \qquad ( 36 )$$

where Tₖ is a triangular number, and can be expressed as:

$${T}_{k} = {\sum }_{j = 1}^{k} j = \frac{1}{2} k ( k + 1 ) = ( \begin{matrix}k + 1 \\ 2\end{matrix} )$$

The coefficients on higher powers of z get successively worse, so this can be written simply as:

$${[ {\sum }_{υ} {C}_{υ} {z}^{υ} ]}^{k} = {\sum }_{l = 0}^{∞} χ ( k , l ) {z}^{l} \qquad ( 37 )$$

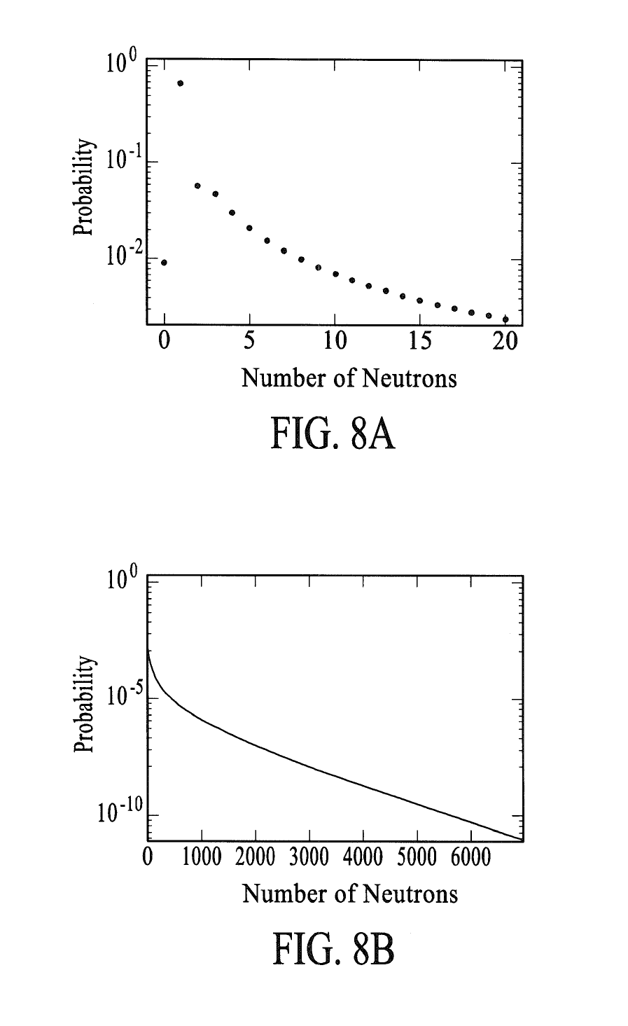

Computation to arbitrarily large values of k is most easily accomplished by iteratively multiplying ΣCᵥz^{v} by itself and collecting terms in powers of z (i.e., the coefficients χ(k, l)) after each iteration. In this way, the proliferation of terms can be controlled. An example with uranium having M=17 is shown in the plots of FIGS. 8A and 8B. FIGS. 8A and 8B illustrate plots of a fission chain neutron multiplicity distribution Pₙ for ²³⁵U for chains initiated by a single neutron with k_{eff}=0.9412, and are examples of plots that may be used in conjunction with embodiments of the method of FIG. 3.

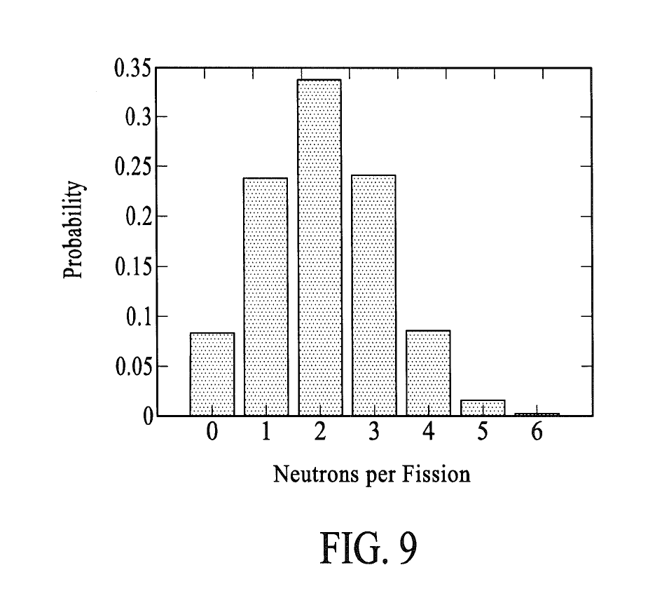

Given the fission chain neutron multiplicity distribution Pₙ and the neutron multiplicity distribution for spontaneous fission C_{S}_{ᵥ}, it is then possible to calculate the fission chain neutron multiplicity distribution for fission chains initiated by spontaneous fission, P_{Sn}. Each neutron created by the spontaneous fission is capable, with probability p, of causing a subsequent fission, and by extension, a fission chain with a neutron multiplicity distributed according to Pₙ. FIG. 9 is a plot that illustrates the spontaneous fission neutron multiplicity distribution for ²³⁸U, and is an example of a plot that may be used in conjunction with embodiments of the method of FIG. 3.

The probability that a spontaneous fission creates no neutrons is just C_{S0} and then there is no chance of having a subsequent fission chain. The probability for a spontaneous fission that creates one neutron followed by a fission chain with n neutrons is simply Cₛ₁×Pₙ. Spontaneous fissions that create two neutrons offer many possibilities as each neutron can initiate a fission chain that makes some number n of neutrons with probability Pₙ. For example, consider the situation where one neutron initiated a fission chain that made seven neutrons, and the other initiated a fission chain that made five. Since independent probabilities multiply, the probability for this to happen would be (C_{S2}×P₇×P₅)+(C_{S2}×P₅×P₇). In general, the probability for a spontaneous fission with two neutrons followed by two fission chains with arbitrary numbers of neutrons could be computed by taking the generating function for h(y), Eq. 30, squaring it, and multiplying the result by C_{S2} where the resulting values of P_{Sn}, just the coefficients on yⁿ.

Using this logic, the analysis can be extended to more complicated situations involving a spontaneous fission that creates an arbitrary number of neutrons which each go on to initiate fission chains that make arbitrary numbers of neutrons. This conclusion is expressed by the generating function in the following Eq. 38:

$${\sum }_{n = 0}^{∞} {P}_{Sn} {y}^{n} = {\sum }_{υ} {{C}_{S υ} [ h ( y ) ]}^{υ} \qquad ( 38 )$$

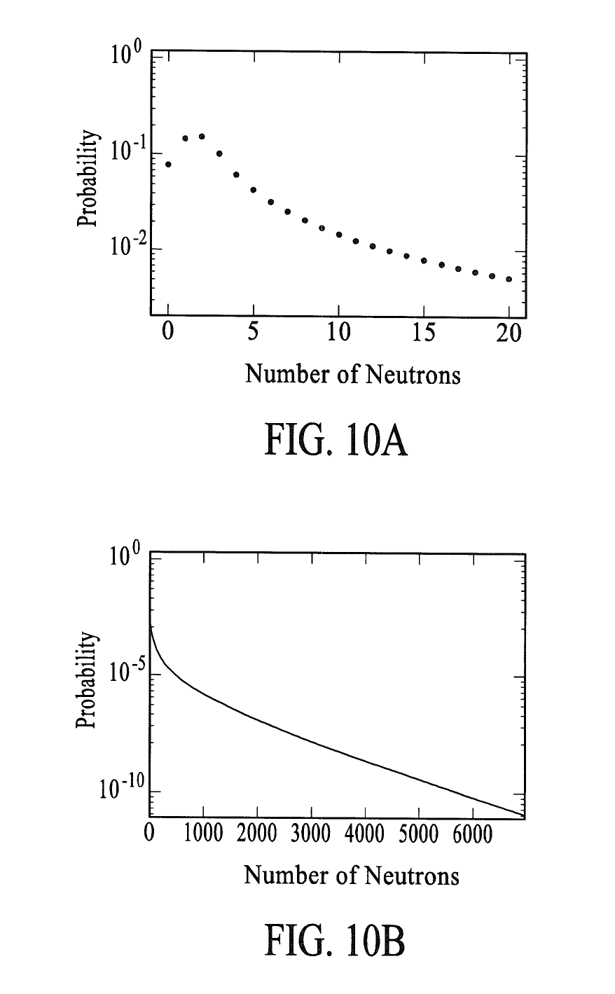

In Eq. 38 above, the values of P_{Sn} are again just the coefficients on yⁿ in the generating function. Numerical values are computed by iteratively multiplying h(y) by itself and collecting terms in powers of y after each iteration, as above. FIGS. 10A and 10B illustrate plots of a fission chain neutron multiplicity distribution P_{Sn} for ²³⁵U for chains initiated by spontaneous fission of ²³⁸U with k_{eff}=0.9412, and with M=17, and are examples of plots that may be used in conjunction with embodiments of the method of FIG. 3.

As shown in FIGS. 2 and 3, a system and process under embodiments performs a particle filtering operation based on Bayesian statistical analysis to refine the probability distribution over the source parameters as each neutron is detected. With regard to recursive Bayesian processors, as a simple example, suppose there is an experiment which counts particles emanating from some source, and that the particles are created according to a Poisson distribution. The waiting time between an arbitrary count and the kth count follows the well known gamma distribution,

$$f ( t , λ , k ) = \frac{{t}^{k - 1} {λ}^{k} {e}^{- λ t}}{( k - 1 ) !}$$

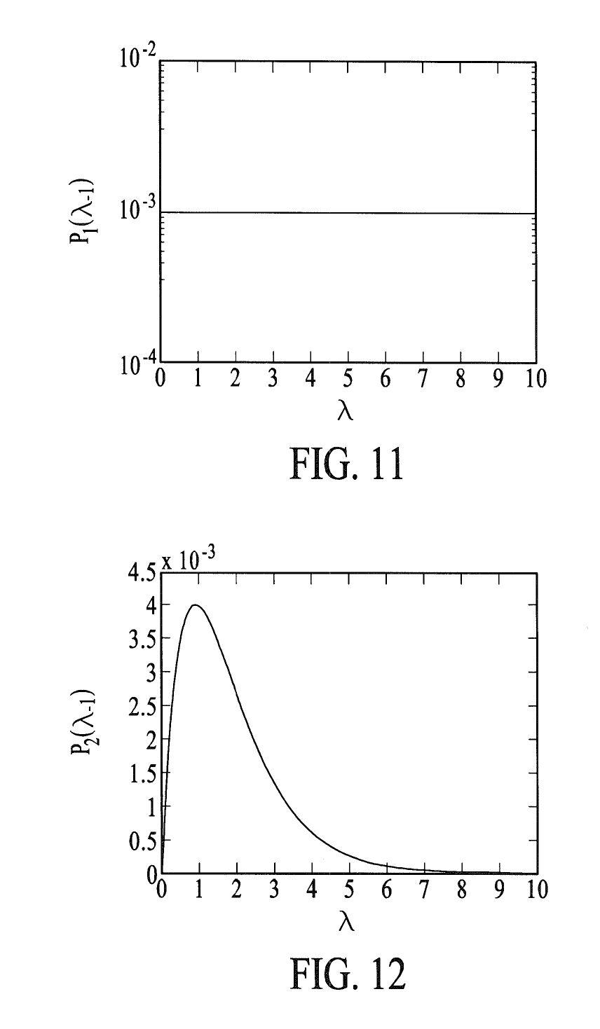

To estimate the parameter λ by considering the inter-arrival time between successive counts (i.e. k=1 above) using a recursive Bayesian analysis, the process starts with a uniform probability distribution sampled at evenly spaced values of λ over some range. For this simple example, consider values of λ between 0 and 10 spaced at intervals of 0.01. The probability distribution P₀(λᵢ) for this case is shown in FIG. 11, and is just a uniform probability distribution with normalization 0.001. FIG. 11 is a plot illustrating P₁(λᵢ) for values of λ between 0 and 10 spaced at intervals of 0.01, and showing a uniform probability distribution.

The plot is refined for each successive counted particle. For example, assume the waiting time between the first and second particles was t₂=1.0927 in some unit of time. From that one measurement, the process estimates the rate λ≈1/t₂. With only one data point, it may not necessarily be a good estimate. The parameter P₂(λᵢ) is defined as:

$$\begin{matrix}{P}_{2} ( {λ}_{i} ) = \frac{f ( {t}_{2} ; {λ}_{i} , 1 ) {P}_{1} ( {λ}_{i} )}{{\sum }_{i} f ( {t}_{2} ; {λ}_{i} , 1 ) {P}_{1} ( {λ}_{i} )} \\ = \frac{{λ}_{i} {e}^{- {λ}_{i} {t}_{2}} {P}_{1} ( {λ}_{i} )}{{\sum }_{i} {λ}_{i} {e}^{- {λ}_{i} {t}_{2}} {P}_{1} ( {λ}_{i} )} ( 41 )\end{matrix} \qquad ( 40 )$$

This probability distribution tells the probability, given a waiting time t₂ between the first and second counts, of the average rate parameter being λᵢ. Some values of λ naturally have a higher probability than others. The probability distribution P₂(λᵢ) under an example is shown in FIG. 12. FIG. 12 is a plot P₂(λᵢ) for values of λ between 0 and 10 spaced at intervals of 0.01 with t₂=1.0927 and P₁(λᵢ) as shown in FIG. 11.

Now, after a third count in the detector, the estimates of the rate parameter can be yet further refined. For example, if the time interval between the second and third particles is t₃=0.0118 in whatever units, the value P₃(λᵢ) is given as:

$$\begin{matrix}{P}_{3} ( {λ}_{i} ) = \frac{f ( {t}_{3} ; {λ}_{i} , 1 ) {P}_{2} ( {λ}_{i} )}{{\sum }_{i} f ( {t}_{3} ; {λ}_{i} , 1 ) {P}_{2} ( {λ}_{i} )} \\ = \frac{{λ}_{i} {e}^{- {λ}_{i} {t}_{3}} {P}_{2} ( {λ}_{i} )}{{\sum }_{i} {λ}_{i} {e}^{- {λ}_{i} {t}_{3}} {P}_{2} ( {λ}_{i} )} ( 43 )\end{matrix} \qquad ( 42 )$$

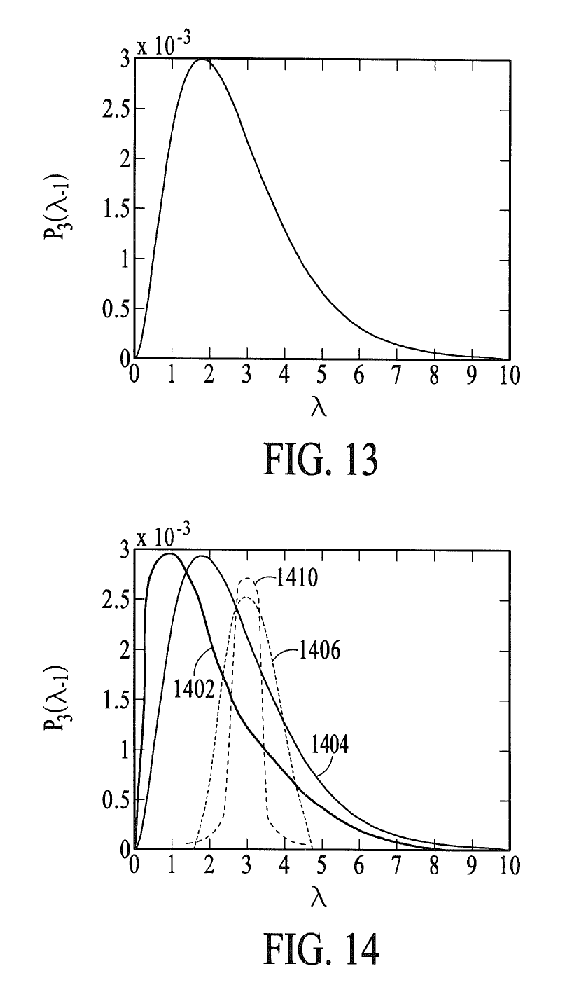

FIG. 13 illustrates the probability distribution P₃(λᵢ) for values of λ between 0 and 10 spaced at intervals of 0.01 with t₃=0.0118 and the P₂(λᵢ) distribution shown in FIG. 12. Continued iterative processing of the rate parameter for each successively detected neutron will yield further refinement and narrowing of the distribution curve around a single value. In general, if the waiting time from the (j−1)th count to the jth count is tⱼ, then the probability distribution is expressed as:

$$\begin{matrix}{P}_{j} ( {λ}_{i} ) = \frac{f ( {t}_{j} ; {λ}_{i} , 1 ) {P}_{j - 1} ( {λ}_{i} )}{{\sum }_{i} f ( {t}_{j} ; {λ}_{i} , 1 ) {P}_{j - 1} ( {λ}_{i} )} \\ = \frac{{λ}_{i} {e}^{- {λ}_{i} {t}_{j}} {P}_{j - 1} ( {λ}_{i} )}{{\sum }_{i} {λ}_{i} {e}^{- {λ}_{i} {t}_{j}} {P}_{j - 1} ( {λ}_{i} )} ( 45 )\end{matrix} \qquad ( 44 )$$

After the jth count, the estimated value of λ might correspond to:

$${λ}_{est} = 〈 λ 〉 = {\sum }_{i} {P}_{j} ( {λ}_{i} ) {λ}_{i} \qquad ( 46 )$$

The estimated value of λest may alternately converge to the value of λᵢ, with i corresponding to max Pⱼ(λᵢ). The mean estimator value will converge over time as each successive neutron is processed. FIG. 14 is an example plot showing the derivation of a single mean estimator value based on successive distribution plots, for the plots of FIGS. 11-13. As shown in FIG. 14, the individual plots 1402, 1404, 1406 and so on, will eventually evolve to a single narrow distribution curve 1410 centered on a central value for λ.

FIG. 4 is a plot that illustrates the convergence of the mean estimator of Eq. 46. The example plot of FIG. 14 shows the evolution of (λ) over a period corresponding to a thousand counts. In this example, Monte Carlo data was generated with a true value of λ=3.

In an embodiment, the array of trial solutions contains separate discrete values for each of the parameters of mass m, Multiplication M, Efficiency ε, and neutron lifetime λ⁻¹. The array is populated with a number of different values for each of the parameters. For example, Table 1 illustrates a number of example values that can be assigned to each of these parameters:

TABLE 1

| | |
|---|---|
| ²³⁸U mass m = | 5 kg, 7.5 kg, 10 kg, 12.5 kg, . . . 60 kg |
| Multiplication M = | 1, 2, 3, . . . 20 |
| Efficiency e = | 0.25%, 0.50%, 0.75%, . . . 3% |
| Neutron lifetime λ⁻¹ = | 20 μs, 30 μs, 40 μs, . . . 200 μs |

The array of trial solutions for the parameters {mᵢ, Mⱼ, eₖ, λ⁻¹ₗ} is populated for i=1 . . . 23, j=1 . . . 20, k=1 . . . 12, l=1 . . . 19. Such an array would contain 104,880 entries.

Since a theoretical array of possible solutions can approach an infinite size, in order to limit the size of the array to a practical size, certain assumptions may be made. For example, in an array of trial solutions under an embodiment, the source may be assumed to be uranium (as opposed to plutonium or other material). For Table 1 above, fission chain multiplicity distributions for chains initiated by spontaneous fission, P_{Sn}, were precomputed for each value of M above. Uranium was assumed, so that the multiplying medium is taken to be ²³⁵U, and the fission chains were initiated by spontaneous fission of ²³⁸U. To speed computation and because of the difficulties involved with computing all the Λ values from Eq. 24, the probability to detect no neutrons within a random time period of length T was taken as given in Eq. 51:

b₀(T)≈e^{-ωT} (51)

In this Eq. 51, ω(F_{S}, P_{Sn}, ε, λ) is a constant that was estimated using a linear fit to log [b₀(T)]=ωT using a range of values of T and Eqs. 23 and 24 for given values of F_{S}, P_{Sn}, ε and λ. Values of ω were precompiled over the full array of trial solutions. Values of eₖ were also pre-computed over the subarray {Mⱼ, εₖ}.

In this way, each time a neutron is counted and the time since the previous neutron determined, I₀(T) from Eq. 18 can quickly be computed for all 104,880 trial solutions. Thus after each neutron, a probability is calculated for every combination of m, M, ε and λ⁻¹.

$${P}_{n} ( {m}_{i} , {M}_{j} , {ɛ}_{k} , {λ}_{l}^{- 1} ) = \frac{{I}_{0} ( T ; {m}_{i} , {M}_{j} , {ɛ}_{k} , {λ}_{l}^{- 1} ) {P}_{n - 1} ( {m}_{i} , {M}_{j} , {ɛ}_{k} , {λ}_{l}^{- 1} )}{{\sum }_{i , j , k , l} {I}_{0} ( T ; {m}_{i} , {M}_{j} , {ɛ}_{k} , {λ}_{l}^{- 1} ) {P}_{n - 1} ( T ; {m}_{i} , {M}_{j} , {ɛ}_{k} , {λ}_{l}^{- 1} )} \qquad ( 52 )$$

The estimated values for m, M, ε and λ⁻¹ parameters after the nth neutron is counted can be taken as the mean estimator Eq. 53 below:

$$\begin{matrix}\{ {m}_{est} , {M}_{est} , {ɛ}_{est} , {λ}_{est}^{- 1} \} = 〈 \{ m , M , ɛ , {λ}^{- 1} \} 〉 \\ = {\sum }_{i , j , k , l} {P}_{n} ( {m}_{i} , {M}_{j} , {ɛ}_{k} , {λ}_{l}^{- 1} ) \{ {m}_{i} , {M}_{j} , {ɛ}_{k} , {λ}_{l}^{- 1} \}\end{matrix} \qquad ( 53 )$$

A second solution uses the values of {mᵢ, Mⱼ, εₖ and λₗ⁻¹} with i, j, k, l corresponding to max Pₙ(mᵢ, Mⱼ, εₖ and λₗ⁻¹). In the second solution, the correct solution in the trial array is obtained by identifying the combination of parameter values in the array that has the highest probability.

The process described above essentially applies a recursive Bayesian processor to correlated neutrons. To verify the effectiveness of such a process, an experiment was performed in which simulated neutron arrival times were generated for a uranium source with a ²³⁸U mass of 10 kg and enough ²³⁵U to make the multiplication M=17. Detection efficiency was set to ε=2.5% with a time constant λ⁻¹=75 μs. The resulting Waterfall and probability distribution plots that were generated for these simulations are shown in FIGS. 5 and 6. Results from the sequential Bayesian processor from two such runs were shown to provide a speed with which the algorithm converges around the true answers in less than one minute without the data transfer and offline analysis by experts that is usually needed to calculate an answer under the current-paradigm.

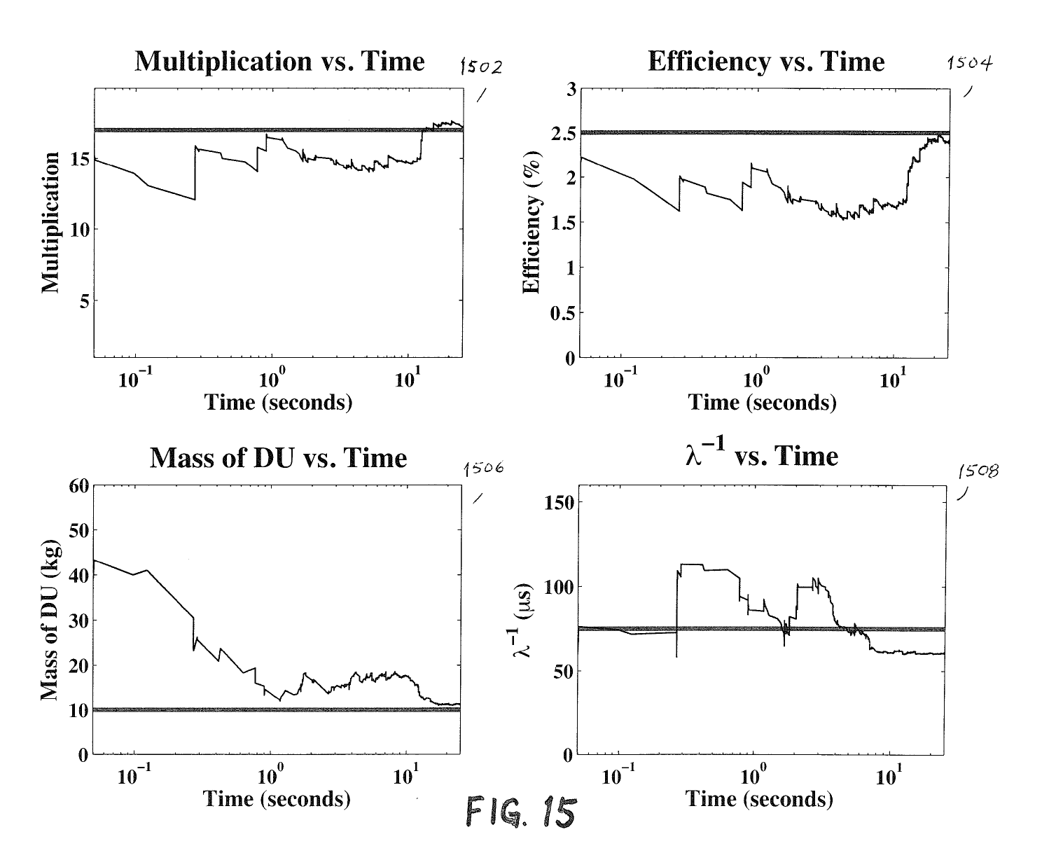

FIG. 15 illustrates the evolution of the [symbol] {m, M, ε and λ⁻¹} [symbol] parameter values over a period of about half a minute for this experiment. The time axis is shown plotted on a logarithmic scale to highlight how the algorithm converges around the correct answer after only a few neutrons have entered the detector. In this example, Monte Carlo data was generated with true values m=10 kg, M=17, ε=2.5%, λ⁻¹=75 μs. Therefore, tests to date on simulated data from uranium have shown that the use of a recursive Bayesian processor on inter-arrival times for detected neutrons typically converges around the correct answers in under a minute. As shown in FIG. 15, for the experiment, plot 1502 illustrates the convergence of the multiplication parameter versus time; plot 1504 illustrates the convergence of the efficiency parameter versus time; plot 1506 illustrates the convergence of the mass parameter versus time; and plot 1508 illustrates the convergence of the λ⁻¹ versus time.

Although embodiments have been described with reference to particular compositions for the source (e.g., uranium), and specific emitted particles (e.g., neutrons), and specific source parameters (e.g., mass, multiplication, efficiency, lifetime), it should be noted that such embodiments may be applied or modified to apply to characterization of other materials and particles.

One or more embodiments of the system illustrated in FIG. 2 may be embodied within a processing device that is mobile, field deployable and capable of being placed in close proximity to an unknown fissioning or potential SNM source. The device may include one or more processors, input/output devices, and volatile or non-volatile memory (e.g., RAM, ROM, disk, etc.) to store programming instructions and data, such as the array 212.

For purposes of the present description, the terms “component,” “module,” and “process,” may be used interchangeably to refer to a processing unit that performs a particular function and that may be implemented through computer program code (software), digital or analog circuitry, computer firmware, or any combination thereof.

It should be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of assaying a source, comprising:
defining an array of possible combinations of values assigned to each of a plurality of parameters that characterize a fissioning property of the source;
receiving a plurality of neutrons in a multiplicity counter that includes a neutron detector and a timing module;
determining a first time interval between a first neutron and a second neutron detected by the neutron detector;
calculating a probability distribution of an array of the parameter values;
determining additional time intervals between each subsequent successive pairs of neutrons detected by the neutron detector;
refining the probability distribution based on the additional time intervals using a recursive Bayesian process to estimate the most probable combination of parameter values.

2. The method of claim 1 wherein the parameters comprise: a multiplication of the source, a mass of a spontaneously fissioning isotope of the source, an efficiency of the neutron detector, and an average neutron lifetime of the detected neutrons.

3. The method of claim 2 further comprising:
determining a first probability of each combination of parameters from the time interval between detected neutrons; and
updating the probability distribution for each combination of parameters with the probability distribution calculated from the most recent time interval between successive neutrons.

4. The method of claim 3 further comprising: identifying the most probable combination of source characteristics of the unknown source based on most recent probability distribution obtained after a defined plurality of time intervals.

6. The method of claim 2 further comprising using the estimated rate parameter as an index to the array of possible combinations.

7. The method of claim 6 further comprising: defining a threshold value to indicate a final rate parameter value after a certain number of time intervals have been determined, the threshold value representing a minimum change in the most probable value of the rate parameter to derive the final rate parameter.

8. The method of claim 7 further comprising: identifying a most probable combination of fission characteristics of the unknown source based on the final rate parameter.

9. The method of claim 1 wherein the source comprises uranium.

10. A method of assaying an unknown source, comprising:
detecting the arrival of a plurality of neutrons sequentially emitted from an unknown source into a multiplicity counter;
determining a time interval between each successive pair of neutrons of the plurality of neutrons;
upon detection of a neutron in the multiplicity counter, iteratively applying a Bayesian statistical process to identify a most probable combination of characteristics of the unknown source

11. The method of claim 10 wherein the source characteristics comprise: a multiplication of the source, a mass of a spontaneously fissioning isotope of the source, an efficiency of the neutron detector, and an average lifetime of a neutron of the plurality of neutrons.

12. The method of claim 11 further comprising: defining a threshold value to indicate a final set of source parameter values after a certain number of time intervals have been examined, the threshold value representing a minimum change in the most probable value of the rate parameter to derive the final rate parameter.

13. The method of claim 12 further comprising: identifying the most probable combination of fission characteristics of the unknown source based on the final probability distribution.

14. A method of assaying a source, comprising:
defining an array of trial solutions, each trial solution specifying a combination of fissile parameters characterizing the source;
determining a time interval between each successive pair of neutrons of the plurality of neutrons detected in a multiplicity counter;
upon detection of a neutron in the multiplicity counter, iteratively applying a Bayesian statistical process to derive the most probable values for the source parameters of the plurality of neutrons using the time interval for each successive pair of neutrons;
updating a probability for each trial solution over the array using a most recent time interval;
identifying a most probable combination of fission characteristics of the unknown source based on the most probable trial solution.

15. The method of claim 14 wherein the fissile parameters comprise: a multiplication of the source, a mass of a spontaneously fissioning isotope of the source, an efficiency of the neutron detector, and a lifetime of a neutron of the plurality of neutrons.

16. The method of claim 15 further comprising: identifying a most probable combination of fission characteristics of the source by comparing the single rate parameter to an array indexed by different rate parameters, wherein the array comprises a defined array of possible combinations of values assigned to each of a plurality of fissile parameters.

17. The method of claim 16 further comprising: defining a threshold value to indicate a final rate parameter value after a sufficient number of time intervals have been determined, the threshold value representing a minimum change in the most probable value of the rate parameter to derive the final rate parameter.

18. A system of assaying an unknown source, comprising:
a memory storing an array of possible combinations of values assigned to each of a plurality of fission characteristics related to the source;
a multiplicity counter receiving a plurality of neutrons, the multiplicity counter including a neutron detector and a timing module;
a time interval calculator determining a first time interval between a first neutron and a second neutron detected by the neutron detector;
a probability calculator calculating a probability distribution of an array of the parameter values;
a component determining additional time intervals between each subsequent successive pairs of neutrons detected by the neutron detector; and
particle filter component refining the probability distribution based on the additional time intervals using a recursive Bayesian process to estimate the most probable combination of parameter values.

19. The system of claim 18 wherein the fission characteristics comprise: a multiplication of the source, a mass of a spontaneously fissioning isotope of the source, an efficiency of the neutron detector, and a lifetime of a neutron of the plurality of neutrons.

20. The system of claim 19 wherein the probability calculator further determines a first probability of each combination of the possible combinations based on an estimated rate parameter; and updates a probability for the each combination using the refined estimated rate parameter.

21. The system of claim 20 wherein the probability calculator further defines a threshold value to indicate a final rate parameter value after a sufficient number of time intervals have been determined, the threshold value representing a minimum change in the most probable value of the rate parameter to derive a final rate parameter.

22. The system of claim 21 wherein the probability calculator further identifies a most probable combination of fission characteristics of the unknown source based on the final rate parameter.

23. The system of claim 19 wherein the probability calculator uses the estimated rate parameter as an index to the array of possible combinations.

24. The system of claim 23 wherein the probability calculator further defines a threshold value to indicate a final rate parameter value after a sufficient number of time intervals have been determined, the threshold value representing a minimum change in the most probable value of the rate parameter to derive the final rate parameter.

25. The system of claim 24 wherein the probability calculator further identifies a most probable combination of fission characteristics of the unknown source based on the final rate parameter.

26. The system of claim 25 further comprising an analysis component identifying a most probable combination of values for the plurality of fission characteristics from the array using the true value of the rate parameter.
